(19) United States
(12) Patent Application Publication
(10) Pub. No.: US 2005/0195724 A1
(43) Pub. Date: Sep. 8, 2005

(54) Optical disk device

(75) Inventors: Noboru Mamiya, Mizuho-city (JP); Ken Hirose, Anpachi-Gun (JP); Satoshi Sumi, Gifu-city (JP); Kenji Nakao, Gifu-city (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/066,494

(22) Filed: Feb. 28, 2005

(30) Foreign Application Priority Data
Mar. 8, 2004 (JP) 2004-64704 (P)

(51) Int. Cl. G11B 7/00

(52) U.S. Cl. 369/116; 369/53.26

(57) ABSTRACT

A mark level (peak value) is obtained from an RF signal during recording and the mark level (peak value) is divided by a linear value proportional to a recording power to obtain a normalized peak value. The obtained normalized peak value is compared with a target value to adjust a set value of the recording power. The normalized peak value, which is obtained by dividing measurements of the mark level (peak level) by the linear value for normalization, monotonously decreases along with an increase in the laser power. Therefore, the shift direction of the recording power can be detected based on the normalized peak value. Further, a shift of the recording power can be appropriately detected based on the normalized peak value level because a change in the normalized peak value level in a power margin range is relatively large.

### BACKGROUND OF THE INVENTION

1. Field of the Invention

The present invention relates to an optical disk device for recording and/or reproducing information by using laser beams, which is particularly suitable for adjusting a set value of laser power.

2. Description of the Related Art

Various types of optical recording media such as compact discs (CDs) and digital versatile discs (DVDs) have been currently commercialized and widely used. Of those recording media, recordable type media such as CD-Rs and DVD-Rs use an organic dye as a recording layer material, so the reflection rate of the recording layer changes according to a change in wavelength. In other words, the recording characteristics of those media have wavelength dependence.

The temperature of semiconductor laser raises with time after the semiconductor laser is turned on. In response, the wavelength of an irradiated laser beam shifts. Therefore, it is necessary to dynamically change the recording power for the recording media having wavelength dependence such as CD-Rs and DVD-Rs according to the fluctuation of the wavelength obtained after the semiconductor laser is turned on. Regarding this, JP 3096239 B discloses a technique in which a set value of the recording power is dynamically changed on the basis of an RF signal during recording.

FIG. 10 shows the relationship between a recording signal and an RF signal detected during recording. In FIG. 10, a laser beam is irradiated onto a recording layer at a reproduction power level while the recording signal is in its space portions, and the laser power of the laser beam rises to a recording power level while the recording signal is in its mark portions. However, a mark is not formed immediately after the rising edge of the recording power, so the same amount of the reflected light (RF signal) as that obtained when the laser beam having the recording power level is irradiated to a space portion is obtained. Thereafter, when the temperature of the recording layer rises and the formation of the mark is started, the reflected light level (RF signal) falls in response thereto, and gradually transits to a reflected light level (RF signal) obtained after the mark is formed.

When the reflected light level (a space level in FIG. 10) obtained immediately after the rising edge of the recording power and the reflected light level (a mark level in FIG. 10) at the mark portion are determined, the modulation degree of a reflected light intensity can be calculated and a state in which a recording mark is formed can be monitored in real time during the recording. In the technique described in JP 3096239 B, the space level and the mark level are detected from the RF signal during recording to adjust the recording laser power based on the modulation degree of the reflected light intensity.

In this adjustment method, however, a special hardware configuration such as a peak hold circuit is additionally required to detect the space level which appears for an extremely short period of time. If the laser power is adjusted on the basis of only the mark level, without using the space level, a special hardware configuration such as a peak hold circuit is not required and the configuration can be simplified. In this case, however, there arises a problem in that the laser power cannot be stably adjusted as described below.

FIG. 11 shows mark level (peak value) measurements obtained while changing the recording power in a DVD-R drive. Note that peak values in the figure are shown with the polarity being reversed (lower peak values have higher reflective levels). In the measurements, the relationship between the recording power and the number of PI error lines (the number of error lines in a PI direction in one ECC block) is also shown with dot line. The number of the PI error lines is obtained when data is reproduced after the data is recorded while changing the recording power.

Referring to FIG. 11, it is apparent that the peak value level starts to rise (in other words, the reflected light level starts to fall) when the recording power reaches around 12 mW. This shows that the mark is not formed yet until the recording power reaches 12 mW, the reflected light level rises as the recording power changes, and then the peak value rises (in other words, the reflected light level falls) when the formation of the mark is started after the recording power exceeds around 12 mW.

The peak value continues to rise (in other words, the reflected light level continues to fall) after the recording power exceeds around 12 mW. However, the peak value does not change when the recording power reaches around 21 mW, and the peak value starts to fall (in other words, the reflected light level starts to rise) after the recording power is further raised. This is because after the mark is formed to some extent, the reflected light level does not fall any more, and a rise in a reflected light amount due to a change in the recording power becomes larger.

It is understood that setting the recording power to around 21 mW is optimum when the above-described characteristics and a recording-power margin for PI errors are examined together. However, it is hard to detect a shift in the recording power because a change in the peak value level is small when the recording power is around 21 mW. In addition, it is impossible to promptly detect the shift direction of the recording power from the peak value level because the peak value level is changed from the increase to the decrease at the boundary of around 21 mW. Further, it is impossible to uniformly adjust the laser power over the entire radius of a disk because the disk has large differences in the peak value characteristics at inner, middle, and outer radial positions of the disk. As described above, laser power adjustment cannot be smoothly performed on the basis of only the peak value level.

### SUMMARY OF THE INVENTION

It is an object of the present invention to solve the above-mentioned problems and to provide an optical disk device capable of smoothly adjusting a laser power without a special hardware configuration such as a peak hold circuit.

The present invention provides an optical disk device, including: peak value level obtaining means for obtaining a peak value level corresponding to an amount of light reflected by a disk obtained after a recording mark is formed; normalized peak value level obtaining means for obtaining a normalized peak value level by normalizing the peak value level obtained by the peak value level obtaining means, with a linear value proportional to a recording laser power; and set value adjusting means for comparing the normalized peak value level obtained by the normalized peak value level obtaining means and a target value to adjust a set value of the recording laser power.

In the optical disk device of the present invention, the normalized peak value level obtaining means may obtain the normalized peak value level by dividing the peak value level obtained by the peak value level obtaining means by a value proportional to the recording laser power.

Further, the target value may be set to the normalized peak value level obtained by normalizing the peak value level obtained by the peak value level obtaining means when the recording laser power is set, with the linear value proportional to the recording laser power.

Further, the optical disk device of the present invention may further include linear value correcting means for correcting the linear value according to a change in temperature of a semiconductor laser.

Further, the linear value correcting means may obtain a correction value of the linear value according to the change in temperature of the semiconductor laser on the basis of an adjustment value of the recording laser power adjusted by the set value adjusting means.

More specifically, the linear value correcting means may obtain, on the basis of the adjustment value of the recording laser power adjusted by the set value adjusting means, a change rate a of the recording laser power changed according to the adjustment, obtain a change rate r of a reflection rate of a recording layer on the basis of the change rate a, and obtain a correction rate of the linear value on the basis of the change rate r.

Further, the optical disk device of the present invention may further include target value correcting means for correcting the target value according to a change in temperature of a semiconductor laser.

Further, the target value correcting means may obtain a correction value of the target value according to the change in temperature of the semiconductor laser on the basis of an adjustment value of the recording laser power adjusted by the set value adjusting means.

More specifically, the target value correcting means may obtain, on the basis of the adjustment value of the recording laser power adjusted by the set value adjusting means, a change rate a of the recording laser power changed according to the adjustment, obtain a change rate r of a reflection rate of a recording layer on the basis of the change rate a, and obtain a correction rate of the target value on the basis of the change rate r.

Consequently, according to the present invention, the laser power adjustment can be smoothly performed without additionally requiring a special hardware configuration such as a peak hold circuit. Specifically, the laser power adjustment can be appropriately performed by correcting the linear value or the target value according to a change in temperature of the semiconductor laser as described above, even when there occurs a wavelength shift in a laser beam caused by the change in temperature of the semiconductor laser. Further, as described above, the linear value or the target value can be smoothly corrected according to the adjustment value of the laser power without the additional provision of a temperature sensor or the like.

### BRIEF DESCRIPTION OF THE DRAWINGS

The above and other objects and novel features of the present invention will become apparent from the following detailed description of embodiments taken in conjunction with the accompanying drawings, in which:

FIG. 1 shows a configuration of an optical disk device according to an embodiment of the present invention;

FIG. 2 is a diagram for explaining a normalization method for peak value levels according to Embodiment 1 of the present invention;

FIG. 3 is a diagram for explaining the normalization method for the peak value levels according to Embodiment 1 of the present invention;

FIG. 4 is a flow chart of a laser power adjusting process according to Embodiment 1 of the present invention;

FIG. 5 is a diagram for explaining a normalization method for the peak value levels according to Embodiment 2 of the present invention;

FIG. 6A is a diagram for explaining a laser power adjusting process according to Embodiment 2 of the present invention;

FIG. 6B is a diagram for explaining a laser power adjusting process according to Embodiment 3 of the present invention;

FIG. 7 is a flow chart of the laser power adjusting process according to Embodiment 2 of the present invention;

FIG. 8 is a flow chart of the laser power adjusting process according to Embodiment 3 of the present invention;

FIG. 9 shows verification results of the laser power adjusting process according to Embodiment 3 of the present invention;

FIG. 10 shows a relationship between a recording signal and an RF signal during recording; and

FIG. 11 is a diagram for explaining problems solved by the present invention.

### DETAILED DESCRIPTION OF PREFERRED EMBODIMENTS

Hereinafter, embodiments of the present invention will be described in detail with reference to the drawings. It is to be expressly understood, however, that the following embodiments are for the purpose of illustration only and are not intended to limit the scope of the present invention.

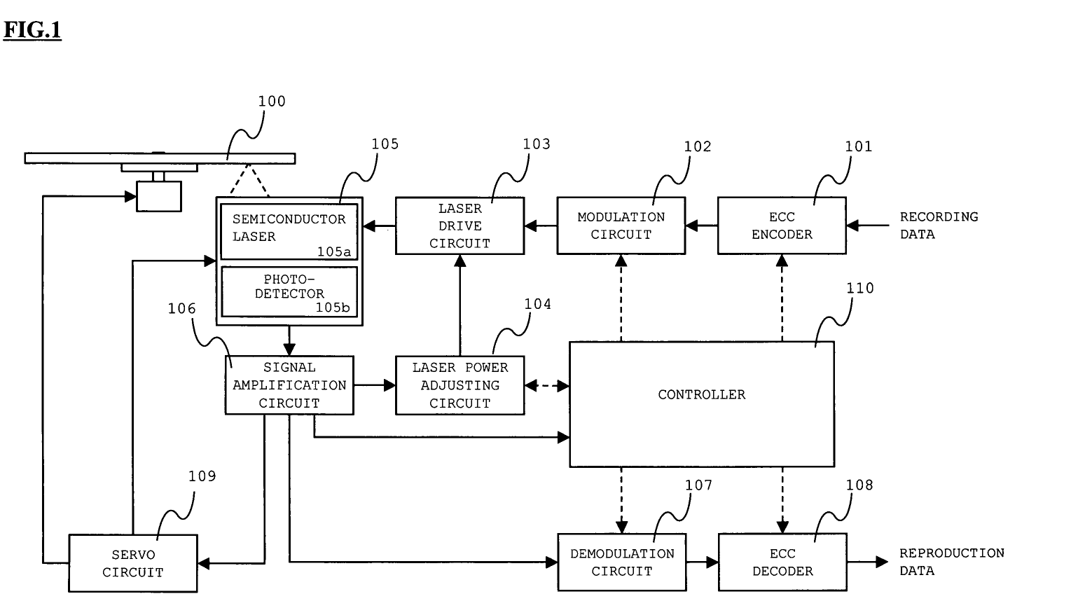

FIG. 1 shows a configuration of an optical disk device according to an embodiment of the present invention.

As shown in the figure, the optical disk device includes an ECC encoder 101, a modulation circuit 102, a laser drive circuit 103, a laser power adjusting circuit 104, an optical pickup 105, a signal amplification circuit 106, a demodulation circuit 107, an ECC decoder 108, a servo circuit 109, and a controller 110.

The ECC encoder 101 adds an error correction code to inputted recording data and outputs the resultant data to the modulation circuit 102. The modulation circuit 102 performs predetermined modulation on the inputted recording data and generates a recording signal to output it to the laser drive circuit 103. The laser drive circuit 103 outputs a drive signal corresponding to the recording signal inputted from the modulation circuit 102 to a semiconductor laser 105a at the time of recording and a drive signal for emitting a laser beam having a reproduction intensity to the semiconductor laser 105a at the time of reproduction. The laser power is adjusted/set by the laser power adjusting circuit 104.

The laser power adjusting circuit 104 sets the laser power for recording or reproduction by, for example, test writing, adjusts the set laser power according to an adjustment value supplied from the controller 110, and outputs the adjusted laser power to the laser drive circuit 103.

The optical pickup 105 includes the semiconductor laser 105a and a photodetector 105b and writes and reads data to and from a disk by converging a laser beam on a track of the disk. Note that the optical pickup 105 further includes an objective lens actuator which adjusts the irradiation state of the laser beam onto the track and an optical system which guides the laser beam irradiated from the semiconductor laser 105a to an objective lens and guides light reflected by a disk 100 to the photodetector 105b.

The signal amplification circuit 106 amplifies and calculates a signal received from the photodetector 105b to generate various types of signals, and outputs the signals to corresponding circuits. The demodulation circuit 107 demodulates a reproduction RF signal inputted from the signal amplification circuit 106 to generate reproduction data and outputs the reproduction data to the ECC decorder 108. The ECC decorder 108 performs an error correction on the reproduction data inputted from the demodulation circuit 107 and outputs the resultant data to a subsequent circuit.

The servo circuit 109 generates a focus servo signal and a tracking servo signal from a focus error signal and a tracking error signal which are inputted from the signal amplification circuit 106 and outputs the focus servo signal and the tracking servo signal to the objective lens actuator of the optical pickup 105. Further, the servo circuit 109 generates a motor servo signal from a wobble signal inputted from the signal amplification circuit 106 and outputs the motor servo signal to a disk drive motor. Furthermore, the servo circuit 109 generates a tilt servo signal from a tilt error signal supplied from the controller 110 and outputs the tilt servo signal to the objective lens actuator of the optical pickup 105.

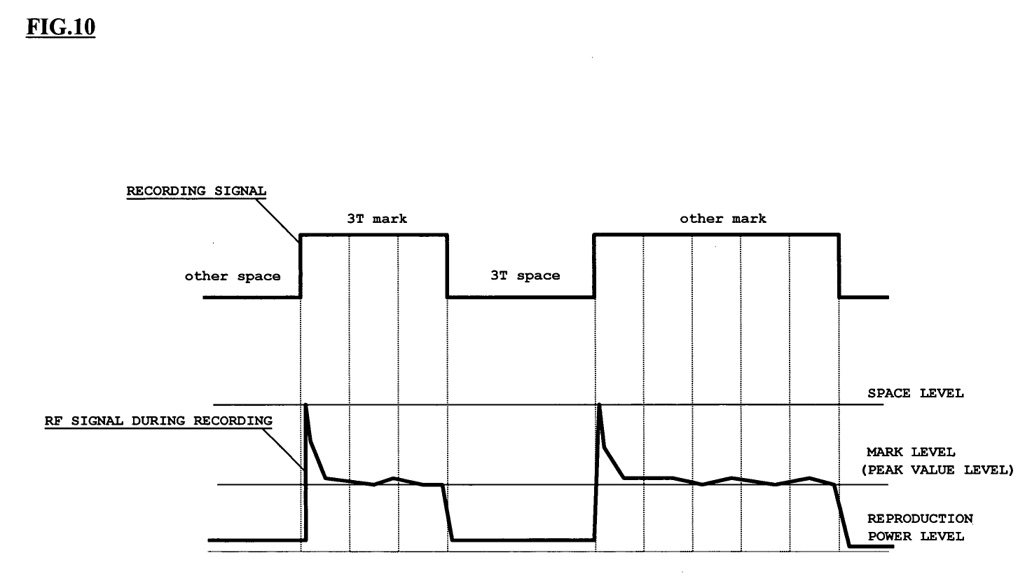

The controller 110 stores various types of data in a built-in memory and controls each part in accordance with a program set in advance. Note that the controller 110 samples the mark levels (peak values) shown in FIG. 10 from an RF signal supplied from the signal amplification circuit 106, obtains an adjustment value for the set value of the laser power from the sampled mark levels, and supplies the adjustment value to the laser power adjusting circuit 104. Specific examples of the laser power adjusting process executed by the controller 110 will become sequentially apparent in embodiments described below.

### Embodiment 1

In this embodiment, the mark levels (peak values) shown in FIG. 10 are sampled from the RF signal obtained during recording, the sampled peak values are normalized by a value (linear recording power) proportional to the magnitude of the recording laser power, and the normalized peak values are used to adjust the recording laser power.

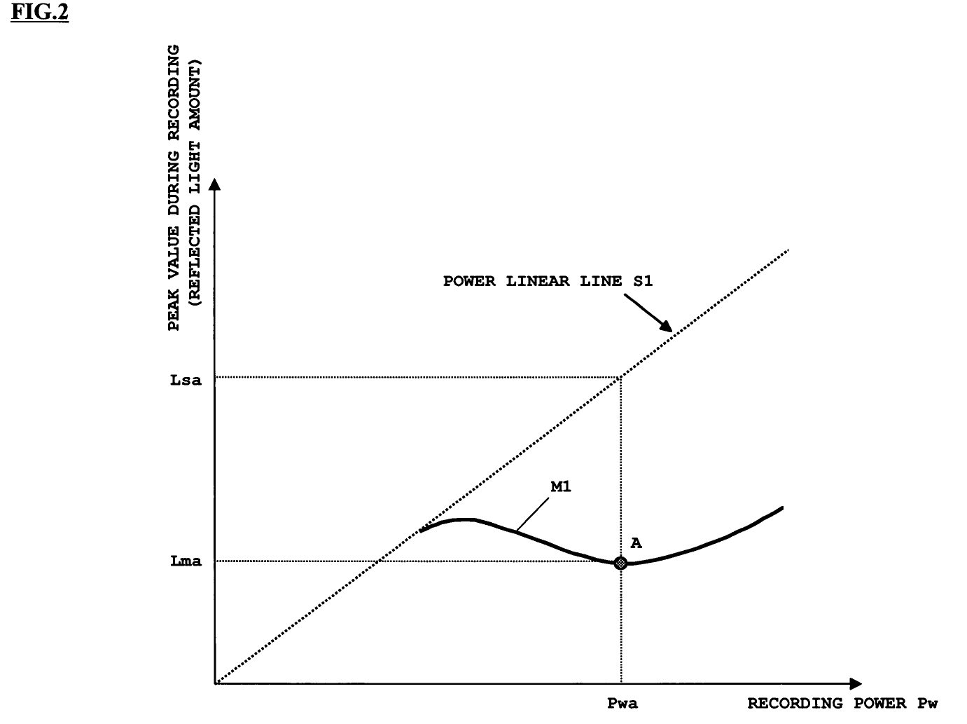

Referring to FIG. 2, a normalization process of the peak values according to this embodiment will be described. In FIG. 2, reference symbol M1 denotes the fluctuation characteristic of the mark levels (peak values) when the recording laser power is changed. Reference symbol S1 denotes a power linear line showing linear values of the recording laser power used for the normalization.

In this embodiment, the mark levels (peak values) are normalized by dividing the mark levels (peak values) by the linear recording power. For example, in FIG. 2, to normalize a peak value of Lma when the recording power is Pwa, the peak value of Lma is divided by a value of Lsa on the power linear line S1 corresponding to the recording power of Pwa.

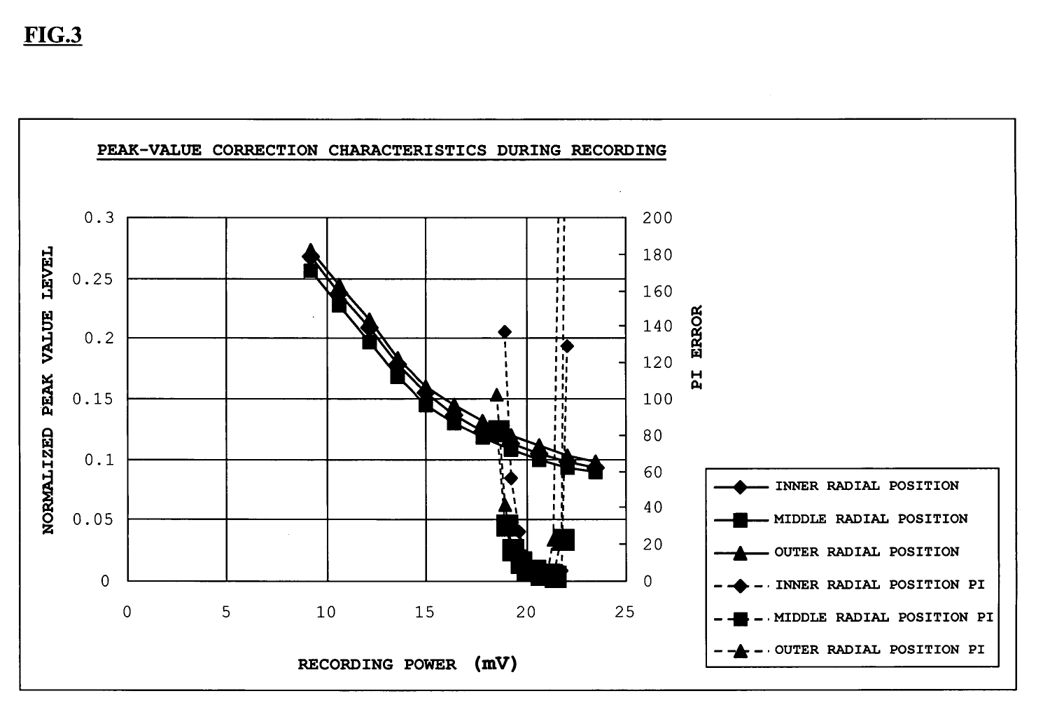

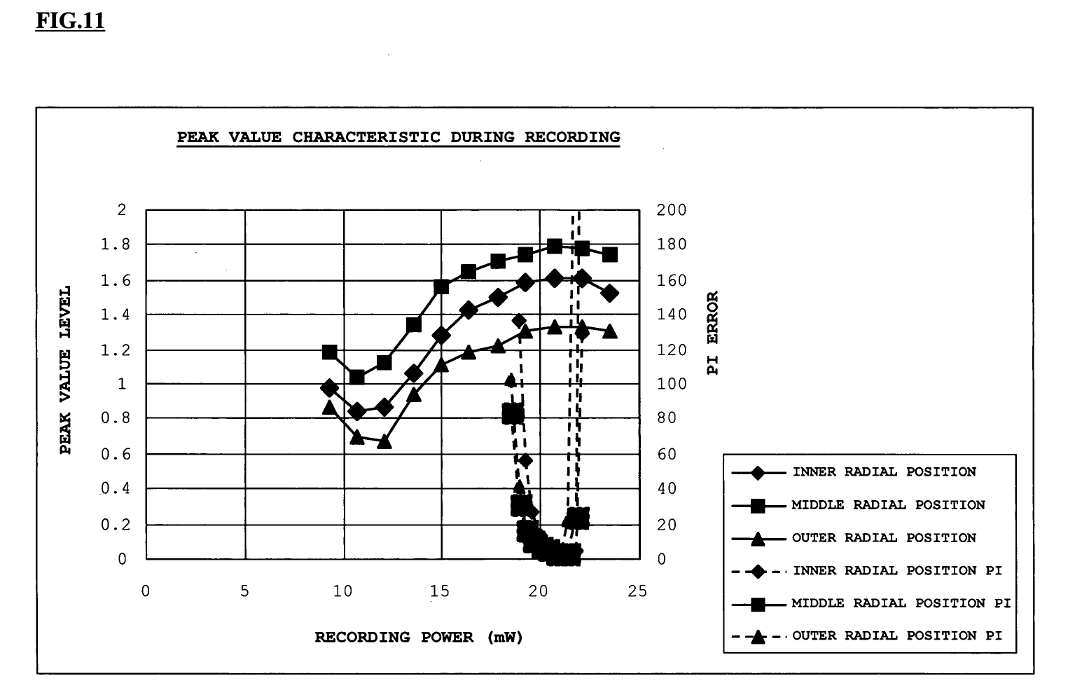

FIG. 3 shows calculation results obtained when the measured mark levels (peak values) explained with reference to FIG. 11 are normalized by dividing them by the linear recording power S1. Note that the value of the recording power is used as the linear recording power S1 as it is. In FIG. 3, the relationship between the recording power and the number of PI error lines (the number of PI error lines in one ECC block) is also shown with dot line, as in FIG. 11.

As shown in the figure, it is understood that the normalized peak values monotonously decrease as the laser power increases. Therefore, the shift direction of the recording power can be promptly detected on the basis of the normalized peak values. The normalized peak value levels change relatively greatly at a power margin range of around 21 mW, so the shift of the recording power can be smoothly detected on the basis of the normalized peak value levels. Further, as shown in the figure, there arises almost no differences in the peak value characteristics at the inner, middle, and outer radial positions of a disk. Therefore, it is possible to uniformly adjust the laser power over the entire radius of the disk.

As described in this embodiment, the peak value levels are normalized to adjust the set value of the recording laser power, on the basis of the normalized peak values, so that the laser power adjustment can be smoothly performed over the entire radius of the disk.

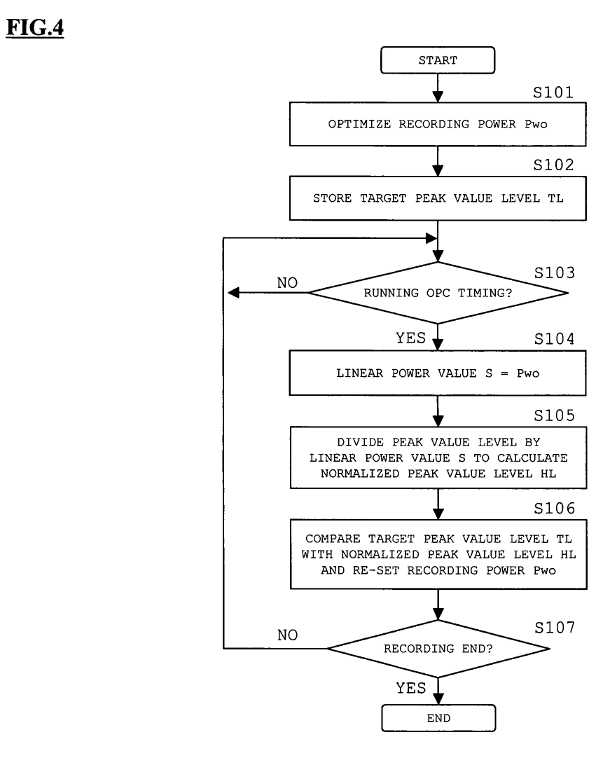

FIG. 4 is a flow chart of a laser power adjusting process according to this embodiment.

When the recording power Pw0 is set by, for example, test writing (S101), the current peak value level is divided by the recording power Pw0 to calculate the normalized peak value level. The normalized peak value level is held as a target peak value level TL (S102).

Then, recording is started and when it becomes a timing of the laser power adjustment (YES in S103), a current recording power Pw0 is set as a linear recording power S (S104).

Next, a current mark level (peak value) is sampled from the RF signal during the recording and the sampled peak value is divided by the linear recording power S to calculate a normalized peak value level HL (S105). The normalized peak value level HL thus calculated is compared with the target peak value level TL, and the set value Pw0 of the recording power is adjusted according to the difference obtained through the comparison. For example, if the normalized peak value level HL is smaller than the target peak value level TL, the set value Pw0 of the recording power is reduced by a level corresponding to the difference. In contrast, if the normalized peak value level HL is larger than the target peak value level TL, the set value Pw0 of the recording power is increased by a level corresponding to the difference (S106).

When the recording power Pw0 is re-set in this manner, a recording operation is carried out by using the recording power Pw0 which has been re-set (NO in S107). When it reaches the next timing of the laser power adjustment (YES in S103), the laser power is re-set in the same manner as above (S104 to S106). This adjusting operation is repeated until the end of the recording operation (S107). When the recording operation ends, the laser power adjusting process ends as well.

According to this embodiment, the laser power adjustment can be smoothly performed without any special hardware configuration such as a peak hold circuit.

### Embodiment 2

In Embodiment 1, the laser power adjustment is performed without considering a change in temperature of the semiconductor laser. However, as described in the related art, the recording characteristics of media such as CD-Rs and DVD-Rs include wavelength dependence, so it is preferable to properly correct the laser power adjusting process according to a wavelength shift caused by a change in temperature of the semiconductor laser. In light of this, in this embodiment, the power linear line S is corrected according to the change in temperature of the semiconductor laser.

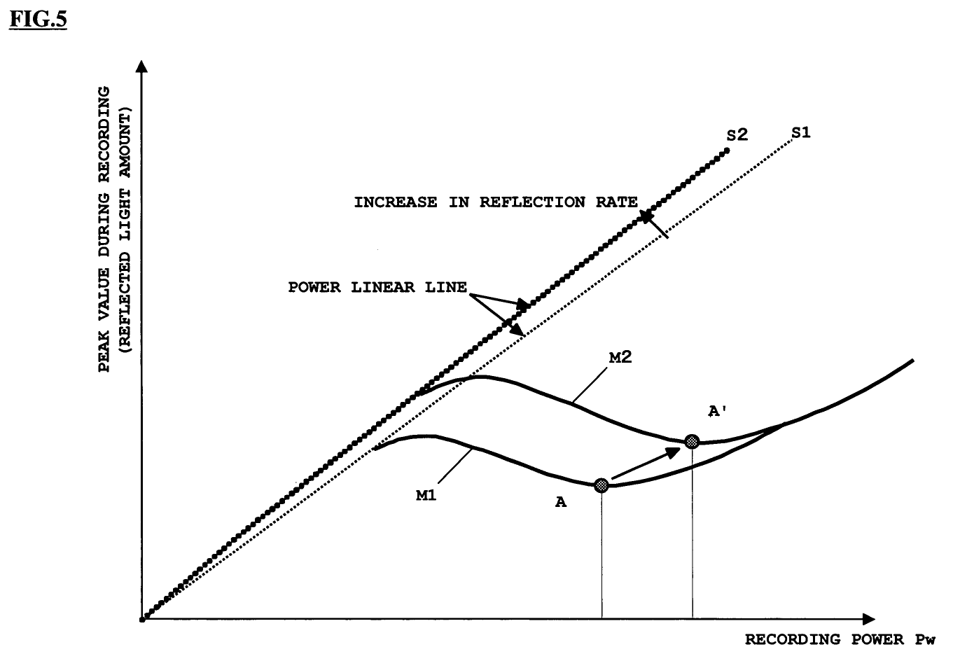

Referring to FIG. 5, a power linear line correcting process according to this embodiment will be described. In the figure, reference symbol M1 denotes the fluctuation characteristic of the mark level (peak value) when the temperature of the semiconductor laser is T1. Reference symbol S1 denotes a power linear line to be used then.

It is assumed that an optimum recording power Pw0 at a temperature of T1 is shown at a point A on the fluctuation characteristic M1. When the temperature of the semiconductor laser rises to T2, the fluctuation characteristic of the mark level (peak value) is changed from M1 to M2, and accordingly the position of the optimum recording power Pw0 is changed to a point A′. At this time, the power linear line S1 is not suitable for the fluctuation characteristic M2 because it is used for the fluctuation characteristic M1. Thus, the power linear line is corrected from S1 to S2, and the fluctuation characteristic of the mark levels (peak values) is normalized by using the power linear line S2.

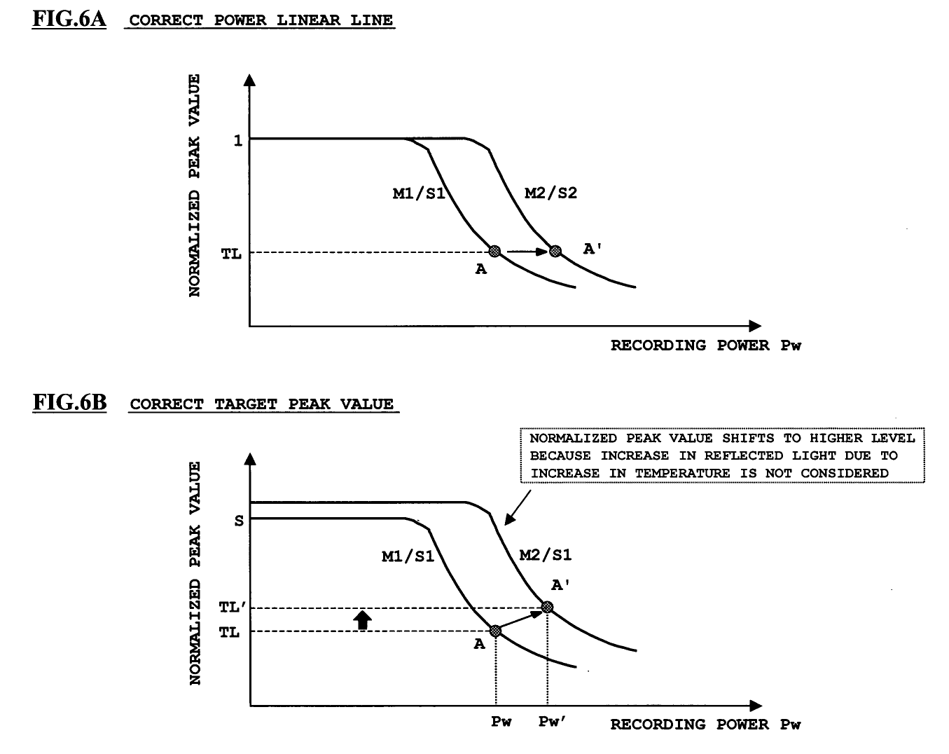

FIG. 6A shows a normalized peak value characteristic when the power linear line is corrected from S1 to S2. As shown in the figure, the position A of the optimum recording power on the normalized peak value characteristic (M1/S1), which has been normalized by dividing the fluctuation characteristic M1 by the power linear line S1, is changed to the position A′ on the normalized peak value characteristic (M2/S2), which has been normalized by dividing the fluctuation characteristic M2 by the power linear line S2. The normalized peak value at the point A is equal to the normalized peak value at the point A′. In other words, the power linear line is corrected from S1 to S2 such that the normalized peak value at the point A is equal to the normalized peak value at the point A′. In this way, it is not necessary to change/correct the target peak value TL in adjusting the laser power (the normalized peak value obtained when the laser power is set), so the recording power adjustment can be performed by using the target peak value TL which has been at the initial stage.

Note that in this embodiment, since the power linear line is corrected according to the change in temperature of the semiconductor laser, it is required to detect the temperature of the semiconductor laser in some way at the time of the laser power adjustment. However, it is difficult to directly measure the temperature of the semiconductor laser. Although a can temperature which is a temperature of can containing the semiconductor laser can be detected, a can temperature sensor or the like is additionally required. Further, a difference in temperature between the actual temperature of the semiconductor laser and the can temperature (temperature propagation characteristics) must be taken into consideration.

As described above, in each of media such as CD-Rs and DVD-Rs, the reflection rate of the recording layer is changed according to a wavelength shift of the laser beam caused by a change in temperature of the semiconductor laser, so the change in temperature of the semiconductor laser can be predicted by monitoring the amount of light reflected by the medium.

Such prediction can be performed on the basis of a signal that shows a change in the reflection rate of the recording layer, for example, the RF signal during recording. For example, the change in the reflection rate of the recording layer is obtained from the mark level (peak value) or reproduction power level shown in FIG. 10, and the change in temperature of the semiconductor laser can be predicted based on the change in the reflection rate of the recording layer.

Alternatively, as described below, the change in temperature of the semiconductor laser or a change in the reflection rate is predicted based on the set value of the recording power after the recording power adjustment, then, the linear recording power value (the power linear line) S is corrected by the change predicted.

For example, in Embodiment 1, when the wavelength shifts according to an increase in temperature of the semiconductor laser, the reflection rate of the recording layer increases. Therefore, the set value Pw0 of the recording power is re-set to a value larger than the last set value through the laser power adjusting process. The difference APw0 between the power set value Pw0 before re-setting and the power set value Pw0 after re-setting corresponds to a fluctuation in the reflection rate of the recording layer, and the fluctuation in the reflection rate is originally caused by the change in temperature of the semiconductor laser. Therefore, the difference APw0 between the set values can be also considered as a result of the change in temperature of the semiconductor laser.

If an initial recording power P1 is adjusted to a recording power P2, an increase rate a of the recording power is expressed by the following equation.
a=P2/P1 (1)

If an increase in the reflected light due to the change in temperature which causes the recording power to increase to P2 is taken into consideration, an initial absorption rate Ab1 of the recording layer and a current absorption rate Ab2 of the recording layer satisfy the following relationship.
Ab2=Ab1/a (2)

Therefore, an initial reflection rate R1 of the recording layer and a current reflection rate R2 of the recording layer are expressed by the following equations.
R1=1−Ab1 (3)
R2=1−Ab1/a (4)
An increase rate r in the reflection rate of the recording layer is expressed by the following equation.
r=(1−Ab1/a)/(1−Ab1) (5)

As described above, when the recording power is multiplied by a, the amount of the reflected light must be multiplied by r, so the linear recording power value S (power linear line) is also needed to be multiplied by r. Therefore, when an initial linear recording power characteristic is indicated by S1 (Pw) and a current linear recording power characteristic is indicated by S2 (Pw), the recording power can be properly adjusted by using the following equation.
S2(Pw)=S1(Pw)×r (6)

Note that, the relationship between the fluctuation in the recording power and the fluctuation in the reflection rate (absorption rate) varies depending on the medium, so the relationship between the change in the recording power and the change in the reflection rate may be set by using experimental or statistical verification. According to the verification made by the inventors of the present invention, it was confirmed that the recording power can be appropriately adjusted without any problems by setting the reflection rate to be increased by 1% when the recording power increases by 1%.

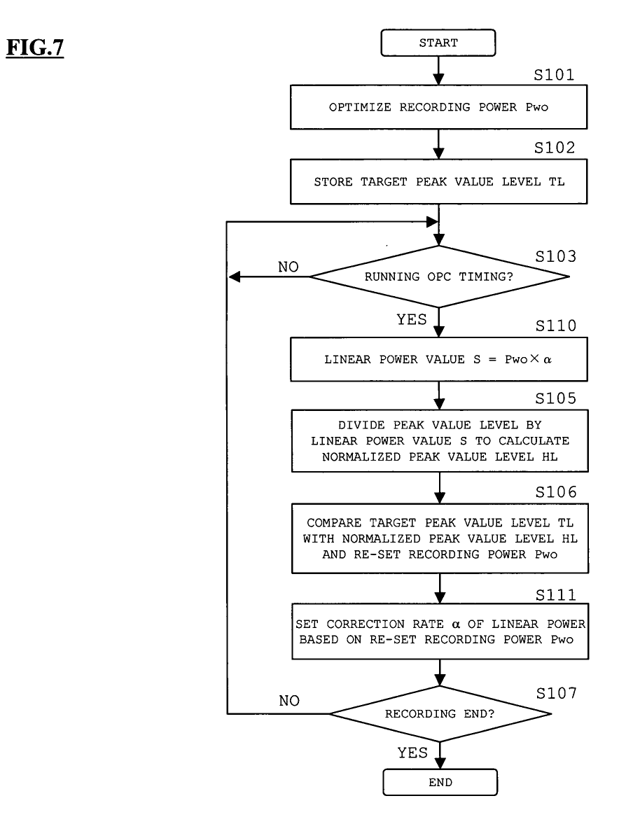

FIG. 7 is a flow chart of the power adjusting process performed by using the power set value Pw0 after re-setting. Note that the flow chart in FIG. 7 is different from that in FIG. 4 in that a step S104 is replaced with the step S110, and a step S111 is newly added. The other steps are identical to those of FIG. 4.

In Embodiment 1, the current recording power Pw0 is set as the linear recording power S (S104 in FIG. 4), but in this flow chart in FIG. 7, the linear recording power S is set to a value obtained by multiplying the current recording power Pw0 by a correction rate a (S110). Here, the correction rate a is set at the time of a last laser power adjustment in the step S111. To be specific, in the step S111, the change r in the reflection rate of the recording layer is obtained from the change rate a between the power set value Pw0 which is re-set in the step S106 and the power set value Pw0 which is initially set (set in S101), as described above, to set the correction rate a of the linear recording power S (for example, the correction rate α=r) based on the change r in the reflection rate of the recording layer.

The correction rate a thus set is used in correcting the linear recording power S at the next timing of the laser power adjustment (YES in S103). To be specific, the current recording power Pw0 is multiplied by the correction rate a which is obtained the last time to set the linear recording power S (S110). Then, the current mark level (peak value) is divided by the linear recording power S to calculate the normalized peak value level HL (S105). Further, the normalized peak value level HL thus calculated is compared with the target peak value level TL to re-set the recording power set value Pw0 (S106).

According to this embodiment, the linear recording power S, which is used for normalization, is corrected according to the change in temperature of the semiconductor laser so that the laser power adjustment can be performed more appropriately compared with Embodiment 1.

### Embodiment 3

In Embodiment 2 described above, the power linear line S is corrected according to the change in temperature of the semiconductor laser. However, in this embodiment, the target peak value level TL is corrected according to the change in temperature of the semiconductor laser.

FIG. 6B shows the normalized peak value characteristics obtained when the fluctuation characteristics M1 and M2 shown in FIG. 5 are each normalized by dividing by the same power linear line S1. As shown in the figure, the position A of the optimum recording power on the normalized peak value characteristic (M1/S1), which is normalized by dividing the fluctuation characteristics M1 by the power linear line S1, is changed to the position A′ on the normalized peak value characteristic (M2/S1), which is normalized by dividing the fluctuation characteristic M2 by the same power linear line S1. Therefore, when the laser power is adjusted by using the normalized peak value characteristic (M2/S1), the target peak value level is required to be changed from TL to TL′.

This change must be performed based on the change in temperature of the semiconductor laser, similarly to Embodiment 2. At this point, the change in temperature of the semiconductor laser may be detected by actually measuring the temperature of the semiconductor laser or the can temperature. However, it is preferred that, as described above in Embodiment 2, the change in temperature or the change in the reflection rate of the recording layer be predicted from the power set value after the laser power adjustment to correct the target peak value level TL based on the prediction, for avoiding difficult measurement and an increase in the number of components (for example, temperature sensor).

As explained with reference to the equations (1) to (5) in Embodiment 2, when the recording power is multiplied by a, the amount of the reflected light must be multiplied by r, so the target peak value level TL2 is also needed to be multiplied by r. Therefore, when it is assumed that the recording power becomes P2 through the laser power adjustment with the initial power being P1 and a peak value at this time being M1, the target peak value TL is re-set as follows.
TL=(M1/P1)×r (7)
Accordingly, the recording power can be adjusted to the optimum power.

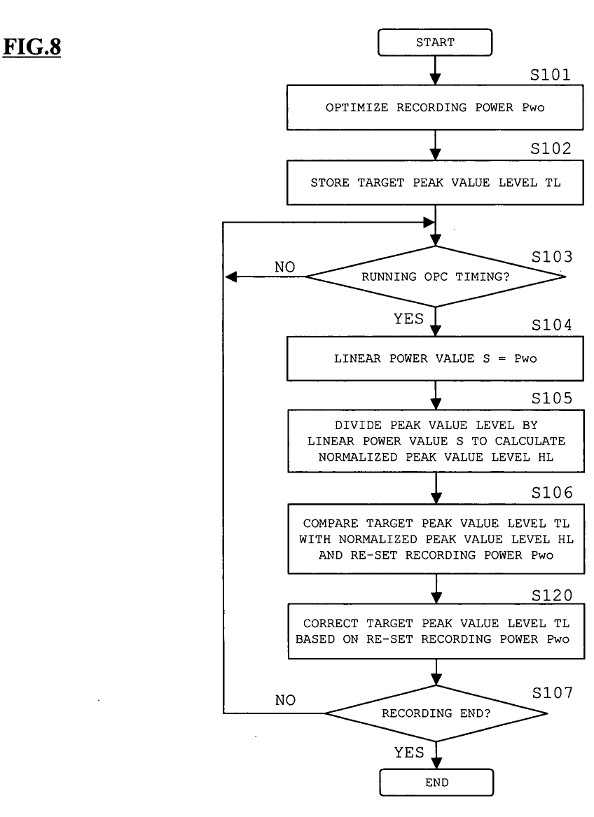

FIG. 8 is a flow chart of a power adjusting process performed by using the change rate of the power set value before and after the re-setting. This process flow is different from that in FIG. 4 in that a step S120 is newly added. The other steps are identical to those in FIG. 4.

In this process flow, the target peak level TL which is obtained at the time of the initial power setting is multiplied by the correction rate a to correct the target peak level TL (S120), and the power is adjusted by using the corrected target peak level TL at the next timing of the power adjustment (S106). Here, the correction rate α is set by obtaining the change r in the reflection rate of the recording layer from the change rate a between the power set value Pw0 which is re-set (re-set in S106) and the power set value Pw0 which is initially set (initial set in S101), as described above.

According to this embodiment, the target peak level TL is corrected according to the change in temperature of the semiconductor laser so that the laser power adjustment can be performed more appropriately compared with Embodiment 1.

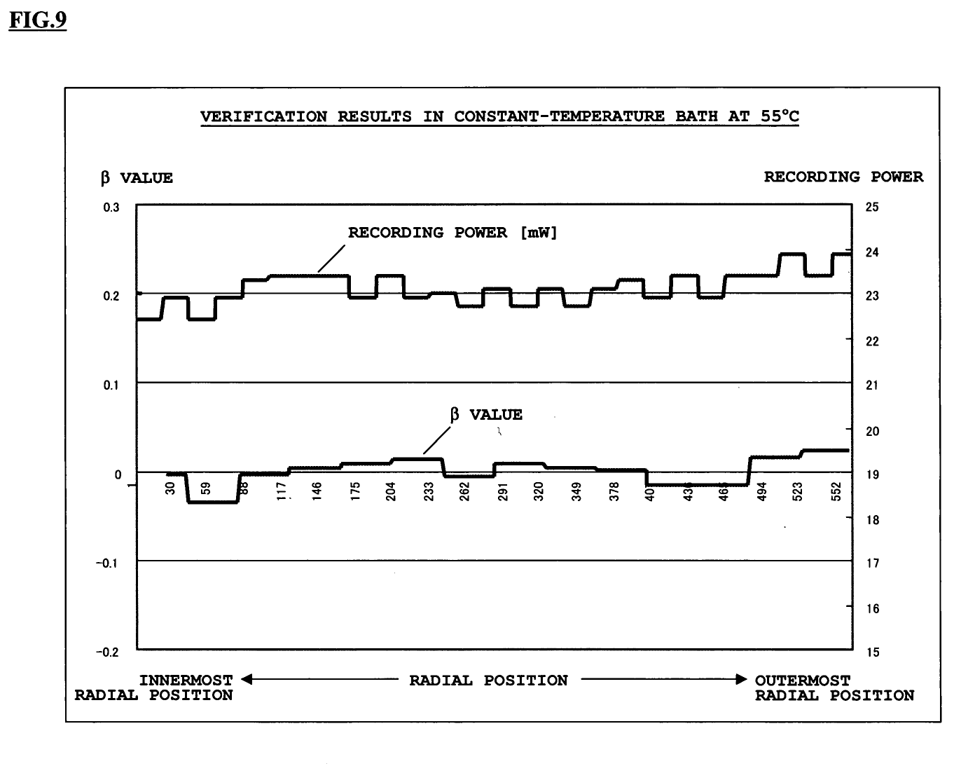

FIG. 9 shows verification results obtained when the above-described process flow (FIG. 8) is applied to a DVD+R drive.

The verification results are obtained by measuring transitions of the recording power and the β value of a recorded signal when a recording operation is performed over the entire radius of a DVD+R medium while adjusting the power in a constant-temperature bath at 55° C. Note that in the verification, the change rate r in the reflection rate is obtained on the assumption that when the recording power increases by 1%, the reflection rate increases by 1% as well. In addition, the change rate r in the reflection rate is used as the correction rate α of the target peak value level TL as it is. Further, the laser power at the time of the power adjustment is used as the linear peak value S which is used for the normalization as it is.

From the figure, it is shown that the recording power is adjusted so as to fall in a range from 22.5 mW to 24 mW and the difference of the β value at this time falls in ±0.02. Therefore, according to the above process flow, the laser power can be appropriately adjusted.

Hereinbefore, the embodiments according to the present invention have been explained, but it is needless to say that the present invention is not limited to the embodiments described above and it is possible to make other various changes.

For example, in the above-described embodiments, the process flows are shown in which the recording power at the time of the power adjustment is used as the linear power value S as it is. However, the method of setting the linear power S is not limited to this and any setting method other than this is applicable as long as it uses a factor which increases in proportion to an increase in the recording power.

In the process flows referred to in Embodiments 2 and 3, the correction rate α of the linear recording power S or the target peak value level TL is obtained based on the power set value after power adjustment, and the correction rate α concerned is applied to the next power adjustment to correct the linear recording power S or the target peak value level TL. However, the correction rate α may be applied to the current power adjustment, not to the next power adjustment, to perform the power adjustment.

That is, the power set value after the power adjustment is temporarily obtained without correcting the power with the correction rate α, and from the obtained power set value, the correction rate α of the linear recording power S or the target peak value level TL is obtained. Further, the linear recording power S or the target peak value level TL is corrected with the correction rate α, and by using the corrected linear recording power S or the target peak value level TL, a final power set value for the current power adjustment is obtained. In this way, the power adjustment can be performed more appropriately compared with the cases as in the flow charts referred to in Embodiments 2 and 3 in which the linear recording power S or the target peak value level TL is corrected with a delay of one cycle of correction.

Furthermore, the embodiments of the present invention allow various changes and modifications as appropriate within the scope of the technical idea of the present invention as set forth in the appended claims.

1. An optical disk device, comprising:
peak value level obtaining means for obtaining a peak value level corresponding to an amount of light reflected by a disk obtained after a recording mark is formed;
normalized peak value level obtaining means for obtaining a normalized peak value level by normalizing the peak value level obtained by the peak value level obtaining means, with a linear value proportional to a recording laser power; and
set value adjusting means for comparing the normalized peak value level obtained by the normalized peak value level obtaining means and a target value to adjust a set value of the recording laser power.

2. An optical disk device according to claim 1, wherein the normalized peak value level obtaining means obtains the normalized peak value level by dividing the peak value level obtained by the peak value level obtaining means by a value proportional to the recording laser power.

3. An optical disk device according to claim 1, wherein the target value is set to the normalized peak value level obtained by normalizing the peak value level obtained by the peak value level obtaining means when the recording laser power is set, with the linear value proportional to the recording laser power.

4. An optical disk device according to any one of claim 1 to 3, further comprising linear value correcting means for correcting the linear value according to a change in temperature of a semiconductor laser.

5. An optical disk device according to claim 4, wherein the linear value correcting means obtains a correction value of the linear value according to the change in temperature of the semiconductor laser on the basis of an adjustment value of the recording laser power adjusted by the set value adjusting means.

6. An optical disk device according to claim 5, wherein the linear value correcting means obtains, on the basis of the adjustment value of the recording laser power adjusted by the set value adjusting means, a change rate α of the recording laser power changed according to the adjustment, obtains a change rate r of a reflection rate of a recording layer on the basis of the change rate a, and obtains a correction rate of the linear value on the basis of the change rate r.

7. An optical disk device according to any one of claim 1 to 3, further comprising target value correcting means for correcting the target value according to a change in temperature of a semiconductor laser.

8. An optical disk device according to claim 7, wherein the target value correcting means obtains a correction value of the target value according to the change in temperature of the semiconductor laser on the basis of an adjustment value of the recording laser power adjusted by the set value adjusting means.

9. An optical disk device according to claim 8, wherein the target value correcting means obtains, on the basis of the adjustment value of the recording laser power adjusted by the set value adjusting means, a change rate a of the recording laser power changed according to the adjustment, obtains a change rate r of a reflection rate of a recording layer on the basis of the change rate a, and obtains a correction rate of the target value on the basis of the change rate r.
